(19) United States
(12) Patent Application Publication
(10) Pub. No.: US 2012/0146262 A1
(43) Pub. Date: Jun. 14, 2012

(54) TREAD DE-MOLDING SYSTEM

(76) Inventors: Brooks M. Adams, Easley, SC (US); Stephen E. Fairbank, Northport, AL (US); Chinglin Pan, Mauldin, SC (US); Chuanyi Wen, Simpsonville, SC (US)

(21) Appl. No.: 13/389,623

(22) PCT Filed: Aug. 31, 2009
(86) PCT No.: PCT/US2009/055493

§ 371 Date: Feb. 9, 2012

(51) Int. Cl. B29C 39/36; B29C 39/22

(52) U.S. Cl. 264/334; 425/436 RM

(57) ABSTRACT

A method and apparatus for tread de-molding is provided and, more particularly, a method and apparatus for removing a tread element such as e.g., a tread belt from a mold is provided. The apparatus may be inserted between upper and lower mold elements to allow for removal of a tread element from a mold. The apparatus may be adjustable for height.

### FIELD OF THE INVENTION

The present invention relates to method and apparatus for tread de-molding and, more particularly, to a method and apparatus for removing a tread element such as e.g., a tread belt from a mold.

### BACKGROUND OF THE INVENTION

Retreaded tires are commercially available and provide an economical option to obtaining additional use of a tire after the tread has worn. The conventional process of retreading generally includes application of a length of tire tread, referred to herein as a tread band, to a tire casing from which the original tread band or a retread band has been removed. Prior to such application, the new tread band is manufactured by a process that includes providing tread features or tread sculpture to the tread band by means of a tread press operation.

Conventionally, the tread press is loaded by using a machine to drag the uncured tread element, e.g., a tread band, across the longitudinal length of the tread press until the tread is located in the proper position. The tread press generally includes an upper mold portion and a lower mold portion with features for creating the tread being located on the lower portion. Once the tread is properly located, the press is closed by forcing the upper and lower mold portions together to mold the tread i.e., create tread features into the tread band.

After molding, the tread band must be removed from the mold. Depending upon the intended tire size the tread band can be heavy and somewhat cumbersome. For some tread patterns, forces must be applied to pull the tread band out of the mold in addition to lifting and moving the tread band. Accordingly, removal of the tread band from a position between the mold elements is manually intensive. Additional challenges are presented when the press is equipped with multiple levels along the vertical direction whereby several treads may be molded at the same time.

Accordingly, an apparatus and method that assists in the removal of a tread element from a mold would be useful. An apparatus and method that can be readily placed between upper and lower mold portions for removal and/or transport of a tread element would also be useful. Such a device or method that can be, in certain embodiments, adjusted for different mold heights and/or introduced from either longitudinal end of the mold would also be useful.

### SUMMARY OF THE INVENTION

Objects and advantages of the invention will be set forth in part in the following description, or may be obvious from the description, or may be learned through practice of the invention.

In one exemplary embodiment of the present invention, an apparatus for removing tread from a mold element is provided. The apparatus includes a conveyor for receipt of the tread. The conveyor defines a longitudinal direction and is movable along the longitudinal direction. The conveyor is connected to a fixed pathway and is configured for sliding in the longitudinal direction along the fixed pathway. A de-molding head is attached to one end of the conveyor and moves with the conveyor. The de-molding head includes at least on drive roller is configured for capturing the tread and advancing the tread over the conveyor.

Variations of this embodiment provide still other exemplary embodiments of the present invention. For example, the fixed pathway may be constructed from a first pair of rails located along the sides of the mold element whereby the conveyor can be suspended over the mold element. The fixed pathway may include a second pair of rails aligned longitudinally with the first pair of rails whereby the conveyor can be positioned adjacent to the mold element. The fixed pathway may also include a third set of rails attached to the second set of rails and foldable with respect to the second set of rails. As such, the third set of rails is configured for connecting the first and the second sets of rails. A movable platform can be provided for supporting the second pair of rails. The platform may be height adjustable relative to the mold element whereby the height of the second pair of rails may be selectively determined.

The conveyor can be constructed as a plurality of rollers that are positioned in adjacent fashion along the longitudinal direction of the conveyor. A plurality of casters can be mounted to the conveyor and positioned between the conveyor and the fixed pathway to facilitate the sliding of the conveyor relative to the fixed pathway.

The de-molding head may include a pair of drive rollers attached to one end of the conveyor and movable with the conveyor. The drive rollers may be selectively movable towards each other whereby the tread may be captured between the two rollers and advanced over the conveyor. A power source may be provided that is connected to at least one of the drive rollers by a drive shaft whereby the power source may be used to rotate the drive rollers to pull the tread onto the conveyor. A pivot arm may be attached to at least one of the drive rollers. At least one actuator can be attached to the pivot arm whereby the pivot arm can be selectively positioned so as to move at least one drive roller towards or away from the other drive roller.

In another exemplary aspect of the present invention, a method for removing tread from a mold element is provided. The method includes the steps of positioning a conveyor proximate to the mold element, pressing a portion of the tread element at a location adjacent to the conveyor, pulling the tread onto the conveyor while simultaneously sliding the conveyor along the longitudinal direction of the conveyor. The tread may be moved onto the conveyor along its longitudinal direction. The positioning step may include positioning the conveyor at a location over the tread and the mold element. The sliding step may include removing the conveyor from its position over the tread and the mold element during the pulling step. This exemplary method may also include adjusting the height of the conveyor relative to the tread.

In certain applications, this exemplary method may include a step of folding the tread over itself during the pulling and sliding steps. Alternatively, or in addition thereto, this method may include turning the tread over during the sliding step. This method may also include positioning the tread between two drive rollers that are moved towards each other. As such, the drive rollers may be rotated to move the tread onto the conveyor during the pulling step.

In still another exemplary embodiment, the present invention provides an apparatus for extracting tread from a mold element. This embodiment includes a fixed pathway for delivering the apparatus into a predetermined position relative to the mold element. A de-molding head is configured for movement along the fixed pathway. The de-molding head includes at least one drive roller that is configured for capturing the tread and pulling the tread towards the de-molding head while the de-molding head moves along the fixed pathway.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of an exemplary embodiment of the present invention located adjacent to a lower mold portion containing a tread belt.

FIG. 2 illustrates the exemplary embodiment of FIG. 1 and shows the conveyor extended over a lower mold portion containing a tread belt.

FIG. 3 illustrates the simultaneous movement of the embodiment of FIG. 2 in a direction away from the mold element while pulling the tread onto the conveyor. This exemplary embodiment may also be used to pull the tread onto the conveyor while the conveyor slides into a position above or over the mold element.

FIG. 4 provides an end view of the exemplary embodiment of FIG. 1 taken from the end containing a de-molding head. FIG. 4 illustrates the conveyor in a position over the tread belt and lower mold element.

FIG. 5 provides a top view of the exemplary embodiment of FIG. 1 at the same end used in FIG. 4. FIG. 5 also illustrates the conveyor in position over the tread belt and lower mold element.

FIG. 6 provides a side view of the de-molding head illustrated in FIGS. 4 and 5.

### DETAILED DESCRIPTION

The present invention relates to method and apparatus for tread de-molding and, more particularly, to a method and apparatus for removing a tread element such as e.g., a tread belt from a mold. For purposes of describing the invention, reference now will be made in detail to embodiments and methods of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used with another embodiment to yield a still further embodiment. Thus, it is intended that the present invention covers such modifications and variations as come within the scope of the appended claims and their equivalents.

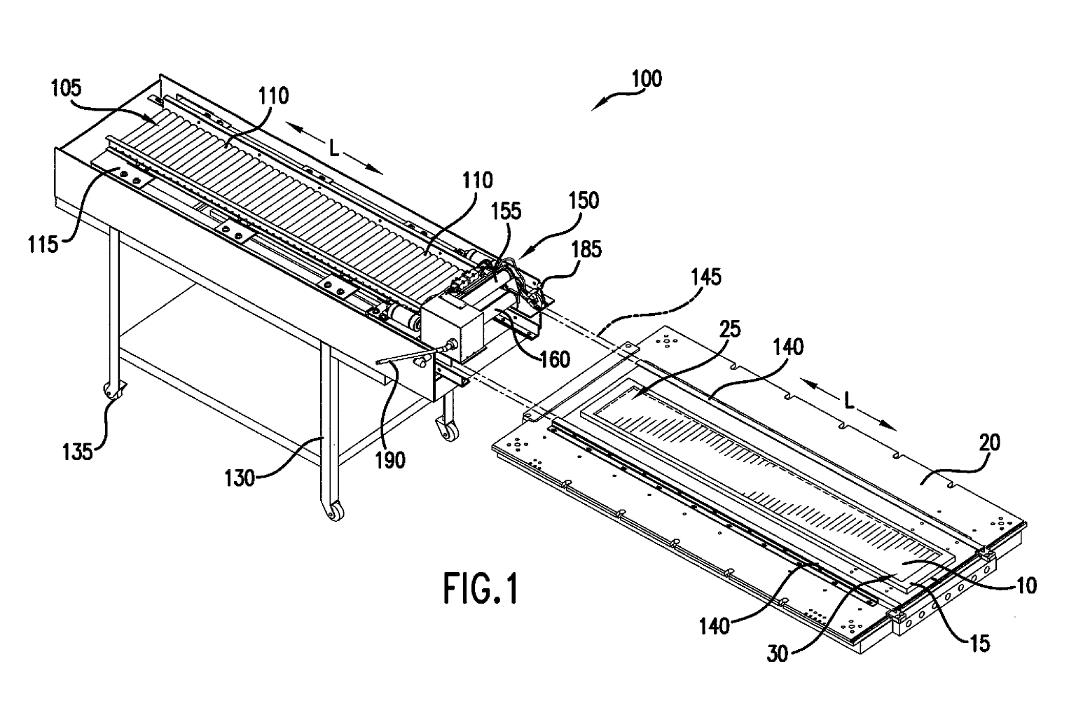

FIGS. 1-3 illustrate an exemplary embodiment of an apparatus 100 for removing a tread or tread belt 10 from a mold. For purposes of clarity, only the lower portion 15 of the mold is shown on a mold press 20. The upper portion of the mold press 20 would be positioned above lower mold portion 15. During molding operations, the upper portion of the mold would be forced against lower portion 15 to mold features from lower mold portion 15 into tread belt 10. After molding operations, the upper portion of mold press 20 would be raised or removed and, as will be described, apparatus 100 would be positioned to remove tread belt 10 from lower mold portion 15.

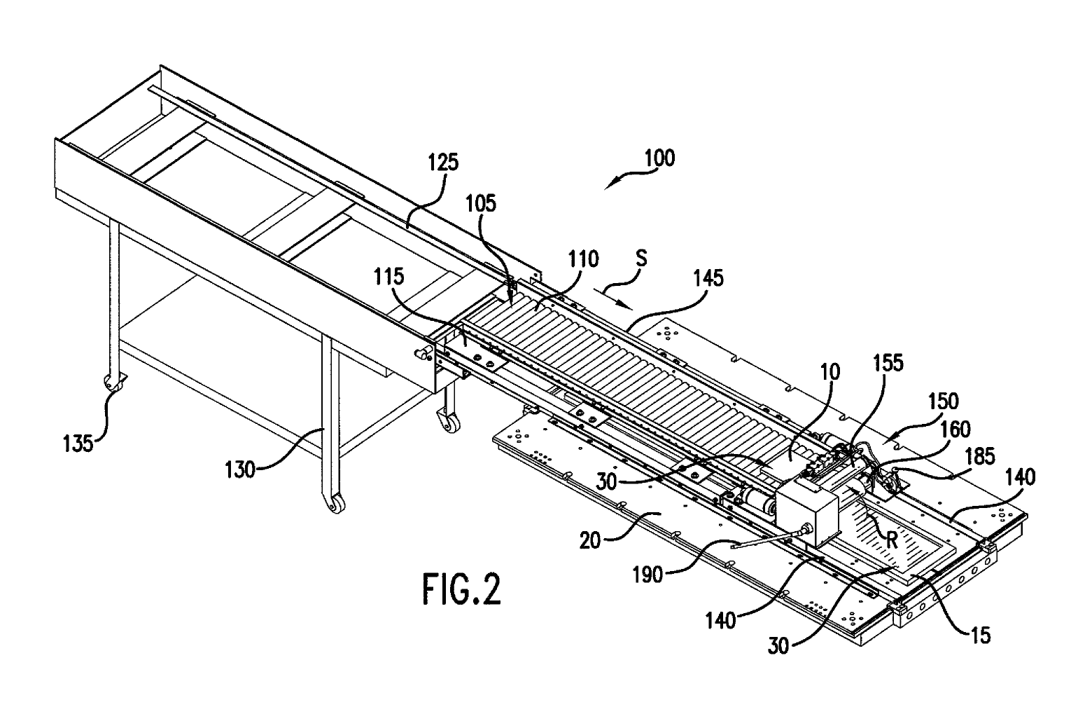

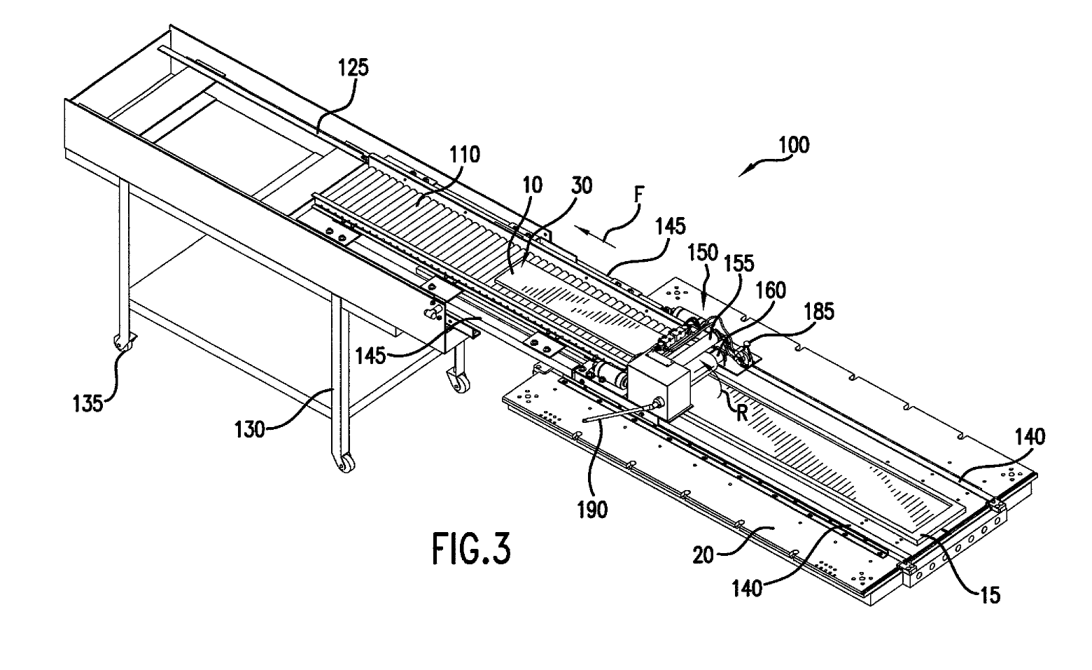

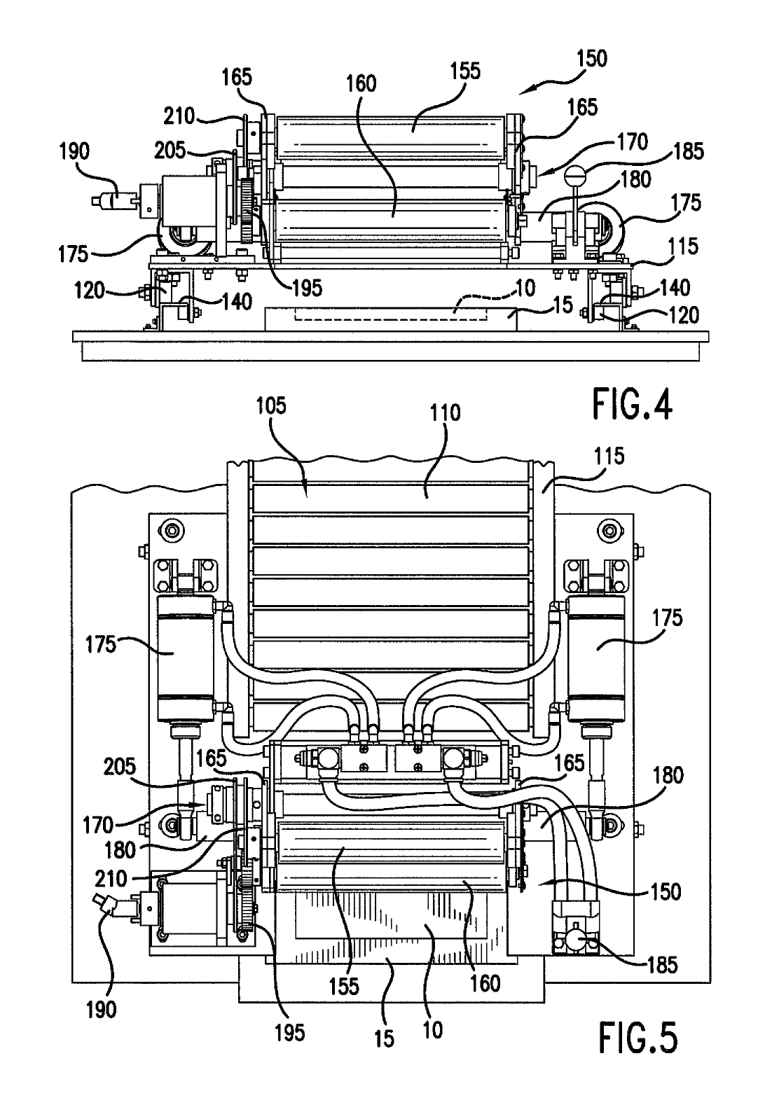

Apparatus 100 includes a conveyor 105 that is constructed from a plurality of rollers 110 placed adjacent to one another along the longitudinal direction L of conveyor 105. Rollers 110 are freely rotatable and allow tread belt 10 to move readily along conveyor 105 as described below. Although rollers 110 are shown as cylinders in FIGS. 1-3, other constructions such as e.g., disks, wheels, and others may also be used. Rollers 110 are mounted to a carriage 115 that includes multiple casters 120 (FIG. 4) that are positioned between the carriage 115 and a fixed pathway that includes a pair of rails 125. As such, casters 120 allow conveyor 105 to slide freely along longitudinal direction L while riding the pair of rails 125 (FIGS. 2, 3).

Conveyor 105 is mounted upon a table or platform 130. For this exemplary embodiment, platform 130 includes wheels 135 that allow an operator to position platform 130 as desired relative to mold press 20 for removal of tread belt 10. Once tread belt 10 has been withdrawn from lower mold portion 15, platform 130 can be used to transport tread belt 10 to the next step in the manufacturing process. Although not shown, platform 130 can be constructed with height adjustment features such that the height of conveyor 105 may be adjusted relative to mold press 20. Alternatively, the height of the mold press 20 or the mold portion 15 could be adjusted to the appropriate height of platform 130 so that conveyor 105 can slide therebetween. Such features would be particularly useful when used with a mold press having multiple molding layers or e.g., multiple molds that are vertically stacked.

As part of the fixed pathway, another pair of rails 140 is positioned along the sides of lower mold portion 15 and are attached to mold press 20. Rails 140 extend the length of lower mold portion 15 and are provided to support conveyor 105 in a position above lower mold portion 15 as shown in FIGS. 2 and 3. Rails 140 are positioned at the same width as rails 125 on platform 130. In order to provide a bridge or transition between rails 125 and rails 140, a third pair of rails 145 are provided as part of the overall fixed pathway. In FIG. 1, rails 145 are shown in phantom lines. In FIGS. 2 and 3, rails 145 are shown connecting between the pair of rails 125 on platform 130 and the pair of rails on mold press 20. By way of example, rails 145 could be connected with rails 125 by hinges or another mechanism that allow rails 145 to be folded and stored away when not in use. Upon positioning platform 130 adjacent to mold press 20 along the longitudinal direction, rails 145 could be extended or unfolded to provide a bridge between rails 125 and rails 140. Accordingly, with rails 145 in position, conveyor 105 can freely slide from platform 130 (FIG. 1) into a position above or over the lower mold portion 15 (FIG. 2). Notably, rails 145 and conveyor 105 are constructed so that conveyor 105 can be readily inserted and withdrawn from a position between upper and lower mold portions.

Once conveyor 105 has been positioned over lower mold portion 15 as shown in FIG. 2, tread belt 10 is fed into a de-molding head 150 attached at the end of conveyor 105. De-molding head 150 moves with conveyor 105 as it slides between the platform 130 and mold press 20. As will be described, de-molding head 150 is configured for pressing or clamping the tread belt 10 while pulling tread belt 10 onto conveyor 105.

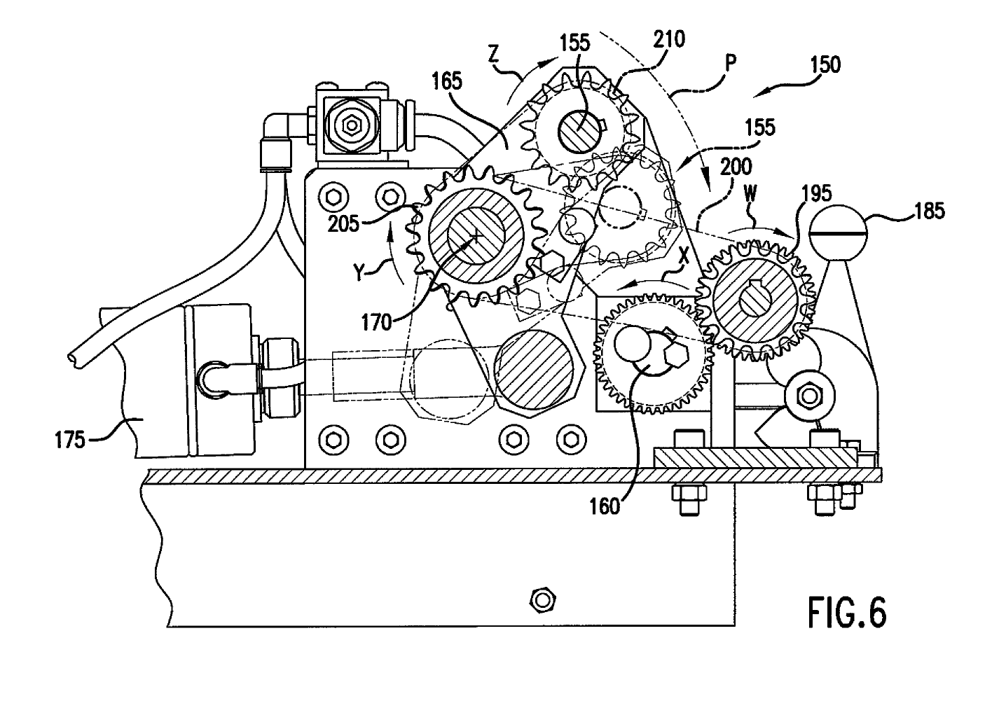

Turning now to FIGS. 4, 5, and 6, de-molding head 150 includes a pair of drive rollers 155 and 160. Although drive rollers 155 and 160 are shown as cylinders in FIGS. 4-6, other constructions such as e.g., disks, wheels, and others may also be used. Drive roller 155 is located on a pair of pivot arms 165 that each pivot around pivot point 170 (FIG. 6). A pair of actuators 175 are also connected to pivots arms 165 by partial shafts 180, which are located on both sides of de-molding head 150. Withdrawing or retracting actuators 175 causes pivot arm 165 to pivot about point 170 and move drive roller 155 towards drive roller 160 as shown by phantom arrow P in FIG. 6. More particularly, FIG. 6 illustrates drive roller 155 in solid lines before being pivoted so as to clamp or press tread belt 10 against drive roller 160. The phantom lines in FIG. 6 illustrate the position of pivot arm 165 after actuators 175 have retracted in order to move (arrow P) drive roller 155 towards driver roller 160 in order to clamp tread belt 10 therebetween. Switch 185 provides for the control of actuators 175 and, therefore, the positioning of drive roller 155 relative to drive roller 160.

Once tread belt 10 has been clamped between drive rollers 155 and 160, tread belt 10 can be advanced onto conveyor 105 by causing drive rollers 155 and 160 to rotate. A power source (not shown) is connected to de-molding head 150 by a drive shaft 190. Rotation of drive shaft 190 causes drive gear 195 to rotate in the direction of arrow W, which in turn rotates drive shaft 160 in direction of arrow X. Chain 200 connects drive gear 195 to idler gear 205, which is mechanical communication with drive roller 155 by way of chain 210 (FIG. 6). Accordingly, rotation of drive shaft 190 also causes idler gear 205 to rotate along the direction of arrow Y, which in turn rotates drive roller 155 in the direction of arrow Z. Notably, drive rollers 155 and 160 rotate in opposite directions in order to pull tread belt 10 from mold press 20 and onto conveyor 105 as shown by arrow R in FIGS. 2 and 3. For the exemplary embodiment of FIGS. 4-6, both drive roller 155 and 160 are powered or driven. However, the present invention includes embodiments where only one drive roller is powered while the other roller is an idler or slave that is not driven.

For convenience, the power source connected to drive shaft 190 may be a portable power tool such as e.g., an electric drill. In addition, shaft 190 may be configured for connection to an electric drill on one end and releasably attached to apparatus 100 on the other. For example, shaft 190 may terminate in a pair of pins that are received into apertures of another shaft or gear on apparatus 100. In such case, an operator could power apparatus 100 by inserting the two pins into connection and then powering the drill. In this way, if the connection is broken, the operation of apparatus 100 is terminated.

Accordingly, in operation, the apparatus 100 including conveyor 105 is placed into position proximate to mold press 20 as shown in FIG. 1. As shown, conveyor 105 and mold press 20 are aligned along their respective longitudinal axis L. Height adjustments can be made to align rails 125 and 140. A third pair of rails 145 is unfolded or otherwise provided to connect and bridge between rails 125 and 140.

Referring to FIG. 2 and as indicated by arrow S, conveyor 105 is then slid along the longitudinal direction L (FIG. 1) from platform 130 to mold press 20 by riding casters 120 from rails 125, over rails 145, and onto rails 140. In the position of FIG. 2, conveyor 105 is now positioned at a location over the lower mold portion 15 and tread belt 10. End 30 of tread belt 10 can now be inserted between drive rollers 155 and 160. As such, tread belt 10 is turned over or folded over itself when end 30 is inserted between drive rollers 155 and 160. Using switch 185, drive roller 155 is pivoted towards drive roller 160 to press and thereby capture tread belt 10 therebetween.

Rotating drive shaft 190 in the direction of arrow W (FIG. 6) causes tread belt 10 to be pulled onto conveyor 105 as shown by arrow R in FIG. 2. At the same time, conveyor 105 is caused to move in the direction of arrow F as shown in FIG. 3. More specifically, conveyor 105 slides along rails 140, rails 145, and then onto rails 125 simultaneously with the pulling of tread belt 10 onto conveyor 105. Because conveyor 105 is free to move along the fixed pathway (a rail assembly in this exemplary embodiment), the action and reaction forces of pulling tread belt 10 onto conveyor 105 causes conveyor 105 to return to its original position on platform 130. Once conveyor 105 has been returned to platform 130, tread belt 10 will be completely removed from the lower mold portion 15. In addition, during this operation, tread belt 10 will be folder over itself until the entire belt 10 has been turned over from its original position in lower mold portion 15. Therefore, apparatus 100 uses a single power source provided through drive shaft 190 to both remove the tread belt 10 from the lower mold portion 15 while moving the conveyor 105.

For the exemplary embodiment described above, the fixed pathway has been described as a rail assembly that includes rails 125, 140, and 145. However, using the teachings disclosed herein, one of ordinary skill in the art will understand that other constructions may be used to provide the fixed pathway. By way of example, grooves with an upper restraining device could be used in place of the rails to provide a path for movement of the conveyor.

Using the teachings disclosed herein, it will be understood that other methods and embodiments may be used within the scope of the present invention and claims that follow. For example, apparatus 100 can also be used to remove tread belt 10 from the lower mold portion 15 without first positioning conveyor 105 over tread belt 10. More particularly, referring back to FIG. 1, the starting position for conveyor 105 can be at a location that is adjacent or proximate—but not over or above—tread belt 10. From this position, end 25 of tread belt 10 can be inserted between drive rollers 155 and 160. Rotation of the drive roller 155 and 160 will then pull tread belt 10 onto conveyor 105 while simultaneously causing conveyor 105 to slide into a position over the lower mold portion 15. Once tread belt 10 has been fully pulled onto conveyor 105 and off of lower mold portion 15, conveyor 105 may then be slid back onto platform 130.

Apparatus 100 can be used to remove tread from an upper mold portion as well. In such case, the starting position for apparatus 100 could be directly under the upper mold portion containing tread belt 10, followed by a process in which tread belt 10 is folded back onto the conveyor. Alternatively, in a manner similar to that of the previous paragraph, the starting position for apparatus 100 could be at a location that is adjacent to—but not below—the upper mold portion, followed by a process in which tread belt 10 is pulled onto conveyor 105.

For certain applications, the use of conveyor 105 may be unnecessary. For example, it may be desirable to use an embodiment of the present invention to pull the tread from the mold without delivering the tread onto a conveyor. In such case, the present invention includes exemplary embodiments where apparatus 100 is equipped without conveyor 105 but with a de-molding head 150 that can be used to extract the tread from the mold.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. An apparatus for removing tread from a mold element, comprising:
a conveyor for receipt of the tread, said conveyor defining a longitudinal direction and being movable along said longitudinal direction;
a fixed pathway to which said conveyor is connected, said conveyor configured for sliding in the longitudinal direction along said fixed pathway; and
a de-molding head attached to one end of said conveyor and movable with said conveyor, said de-molding head comprising at least one drive roller that is configured for capturing the tread and advancing the tread over said conveyor.

2. An apparatus for removing tread from a mold element as in claim 1, where said de-molding head comprises at least two drive rollers attached to one end of said conveyor and movable with said conveyor, said drive rollers also being selectively movable towards each other whereby the tread may be captured between said drive rollers and advanced over said conveyor.

3. An apparatus for removing tread from a mold element as in claim 1, wherein said fixed pathway comprises a first pair of rails located along the sides of the mold element whereby said conveyor can be suspended over the mold element.

4. An apparatus for removing tread from a mold element as in claim 3, wherein said fixed pathway comprises a second pair of rails aligned longitudinally with said first pair of rails whereby said conveyor can be positioned adjacent to the mold element.

5. An apparatus for removing tread from a mold element as in claim 4, further comprising a third set of rails attached to said second set of rails and foldable with respect to said second set of rails, said third set of rails configured for connecting said first and said second sets of rails.

6. An apparatus for removing tread from a mold element as in claim 1, further comprising a movable platform supporting said second pair of rails, said platform being height adjustable relative to the mold element whereby the height of said second pair of rails may be selectively determined.

7. An apparatus for removing tread from a mold element as in claim 1, wherein said conveyor comprises a plurality of rollers positioned in adjacent fashion along the longitudinal direction of the conveyor.

8. An apparatus for removing tread from a mold element as in claim 1, further comprising:
a portable power source; and
a drive shaft connecting said power source and at least one of said drive rollers whereby said portable power source may be used to rotate said drive rollers to pull the tread onto said conveyor.

9. An apparatus for removing tread from a mold element as in claim 1, further comprising:
a pivot arm attached to at least one of said drive rollers; and
at least one actuator attached to said pivot arm, whereby said pivot arm can be selectively positioned so as to move the at least one said drive roller towards or away from the other said drive roller.

10. An apparatus for removing tread from a mold element as in claim 1, further comprising a plurality of casters mounted to said conveyor and positioned between said conveyor and said fixed pathway to facilitate the sliding of said conveyor relative to said fixed pathway.

11. A method for removing tread from a mold element, the mold element defining a longitudinal direction, the method comprising the steps of:
positioning a conveyor proximate to the mold element;
pressing a portion of the tread element at a location adjacent to the conveyor;
pulling the tread onto said conveyor; and
sliding the conveyor along the longitudinal direction simultaneously with said pulling step.

12. A method for removing tread from a mold element as in claim 11, wherein said positioning step further comprises positioning the conveyor at a location over the tread and the mold element.

13. A method for removing tread from a mold element as in claim 12, wherein said sliding step further comprises removing the conveyor from its position over the tread and the mold element during said pulling step.

14. A method for removing tread from a mold element as in claim 11, further comprising the step of folding the tread over itself during said pulling and said sliding steps.

15. A method for removing tread from a mold element as in claim 11, further comprising the step of turning the tread over during said sliding step.

16. A method for removing tread from a mold element as in claim 11, further comprising the step of adjusting the height of the conveyor relative to the tread.

17. A method for removing tread from a mold element as in claim 11, wherein said pressing step further comprises positioning the tread between two drive rollers that are moved towards each other.

18. A method for removing tread from a mold element as in claim 17, further comprising the step of rotating the two drive rollers to move the tread onto the conveyor during said pulling step.

19. A method for removing tread from a mold element as in claim 11, wherein the tread moves along the longitudinal direction during said pulling step.

20. An apparatus for extracting tread from a mold element, comprising:
a fixed pathway for delivering the apparatus into a predetermined position relative to the mold element; and
a de-molding head configured for movement along said fixed pathway, said de-molding head comprising at least one drive roller that is configured for capturing the tread and pulling the tread towards said de-molding head simultaneously with said de-molding head moving along said fixed pathway.

21. An apparatus for extracting tread from a mold element as in claim 20, further comprising a conveyor attached to said fixed pathway and said de-molding head, said conveyor configured for receipt of the tread from said de-molding head.
